(19) United States
(12) Patent Application Publication
(10) Pub. No.: US 2008/0084528 A1
(43) Pub. Date: Apr. 10, 2008

(54) LIQUID CRYSTAL DISPLAY DEVICE

(75) Inventors: Jian-Gang LU, Suwon-si (KR); Chang-Hun LEE, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/764,541

(22) Filed: Jun. 18, 2007

(30) Foreign Application Priority Data
Oct. 10, 2006 (KR) 10-2006-0098661

(51) Int. Cl. G02F 1/1343; G02F 1/1337

(52) U.S. Cl. 349/126; 349/143

(57) ABSTRACT

A liquid crystal display device includes a pixel electrode connected to a gate line and a data line on a first substrate, and a common electrode formed on a second substrate. The pixel electrode includes a stem electrode parallel with the data line, first branch electrodes connected to the stem electrode and inclined at a first angle, second branch electrodes connected to the stem electrode and inclined at a second angle, and a first storage electrode between the first branch electrodes and the second branch electrodes. The first storage electrode is wider than the first branch electrodes and the second branch electrodes. The common electrode includes branch electrodes located between the first branch electrodes, and branch electrodes located between the second branch electrodes. The common electrode also includes a second storage electrode corresponding to the first storage electrode to function as a storage capacitor.

### CROSS REFERENCE TO RELATED APPLICATION

This application claims priority from and the benefit of Korean Patent Application No. 10-2006-0098661, filed on Oct. 10, 2006, which is hereby incorporated by reference for all purposes as if fully set forth herein.

### BACKGROUND OF INVENTION

1. Field of the Invention

The present invention relates to a liquid crystal display device, and more particularly to a liquid crystal display device comprising an electrode having a shape of a branch with good storage capacity.

2. Discussion of the Background

A liquid crystal display (LCD) device includes an LCD panel. The LCD panel includes a first substrate having thin film transistors (TFTs), a second substrate opposing the first substrate, and a liquid crystal layer disposed between the first substrate and the second substrate. Since the LCD panel does not generate its own light, a backlight unit may be provided behind the first substrate.

A pixel electrode is provided in the first substrate, and a common electrode is provided in the second substrate. The liquid crystal layer having liquid crystal molecules is disposed between the pixel electrode and the common electrode, and the alignment of liquid crystal molecules in the liquid crystal layer is controlled by an electric field generated by a potential difference between the pixel electrode and the common electrode.

Some LCD devices employ a structure in which the pixel electrode and the common electrode are patterned so that a pixel area can be divided into sub-pixel areas. The pixel electrode and the common electrode are patterned to be separated by a distance when viewed in plan, and the electric field is generated by a potential difference between the pixel electrode and the common electrode.

However, according to the LCD device employing such a structure, the pixel electrode is provided to have a shape of a thin branch. Because the pixel electrode has a smaller pattern than the pattern of the pixel area, a storage capacity of the LCD device with a pixel electrode having a branch shape may be smaller than the storage capacity of a conventional LCD device. If the storage capacity is decreased, a data voltage may be insufficiently charged and a kickback voltage may be increased. Specifically, the potential difference between the pixel electrode and the common electrode may be decreased due to parasitic capacitance in the TFT if the pixel electrode has a low storage capacity. This is called the kickback voltage. If the kickback voltage has a high value, the kickback voltage may cause poor images due to flickering.

Also, in an LCD device with a pixel electrode having a branch shape, there may be regions where the direction of the electric field is not uniform. If the electric field direction is not uniform, the orientation of liquid crystals may be more random and uncontrolled, which may result in a decreased aperture ratio of the LCD device.

### SUMMARY OF THE INVENTION

This invention provides an LCD device having an increased storage capacity to decrease a kickback voltage.

The present invention also provides an LCD device having a decreased texture to improve image quality.

Additional aspects of the present invention will be set forth in part in the description which follows and, in part, will be obvious from the description, or may be learned by practice of the present invention.

The present invention discloses a liquid crystal display device including a first insulating substrate, a gate line and a data line arranged on the first insulating substrate and extending to cross with each other to define a pixel area, a second insulating substrate opposing to the first insulating substrate, a pixel electrode arranged in the pixel area and connected to the data line, and a common electrode arranged on the second insulating substrate. The pixel electrode includes a stem electrode arranged parallel with the data line, a plurality of first branch electrodes connected to the stem electrode and inclined at a first angle with respect to an extending direction of the gate line, a plurality of second branch electrodes connected to the stem electrode and inclined at a second angle with respect to an extending direction of the gate line, and a pixel storage electrode arranged between the first branch electrodes and the second branch electrodes and having a width greater than a width of the first branch electrodes and a width of the second branch electrodes. The common electrode includes an upper pixel area third branch electrode arranged between and substantially parallel with the first branch electrodes, a lower pixel area third branch electrode arranged between and substantially parallel with the second branch electrodes, and a common storage electrode corresponding to the first storage electrode.

The present invention also discloses a liquid crystal display device comprising: a first insulating substrate, a gate line and a data line arranged on the first insulating substrate and crossing with each other to define a pixel area, a pixel electrode comprising a stem electrode arranged parallel with the data line, a plurality of pixel branch electrodes connected to the stem electrode and inclined at a predetermined angle with respect to an extending direction of the gate line, an edge electrode arranged at connecting areas between the stem electrode and the pixel branch electrodes and extending between the pixel branch electrodes, and a pixel storage electrode having a width greater than a width of a pixel branch electrode, a second insulating substrate opposing the first insulating substrate, and a common electrode arranged on the second insulating substrate and comprising common branch electrodes arranged between and substantially parallel with the pixel branch electrodes, and a common storage electrode corresponding to the pixel storage electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of a first substrate of an LCD device according to a first exemplary embodiment of the present invention.

FIG. 2 is a plan view of a common electrode of the LCD device according to the first exemplary embodiment of the present invention.

FIG. 3 is a plan view of the pixel electrode and the common electrode in the LCD device according to the first exemplary embodiment of the present invention.

FIG. 4 is a sectional view taken along line IV-IV in FIG. 1.

FIG. 5A and FIG. 5B are schematic diagrams to explain an alignment of a liquid crystal molecule in the LCD device according to the first exemplary embodiment of the present invention.

FIG. 6 is a plan view of a pixel electrode of an LCD device according to a second exemplary embodiment of the present invention.

FIG. 7 is a plan view of a portion of the pixel electrode and the common electrode in the LCD device according to the second exemplary embodiment of the present invention.

FIG. 8 is a plan view of an LCD device according to a third exemplary embodiment of the present invention.

FIG. 9A and FIG. 9B are schematic diagrams to explain an alignment of a liquid crystal molecule in the LCD device according to the third exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In this specification, if “An angle is between A degrees and B degrees” is said, the “angle” does not include “A degrees” nor “B degrees”. For example, if it is said that the angle is between 0 degrees and 45 degrees, the angle does not include 0 degrees or 45 degrees.

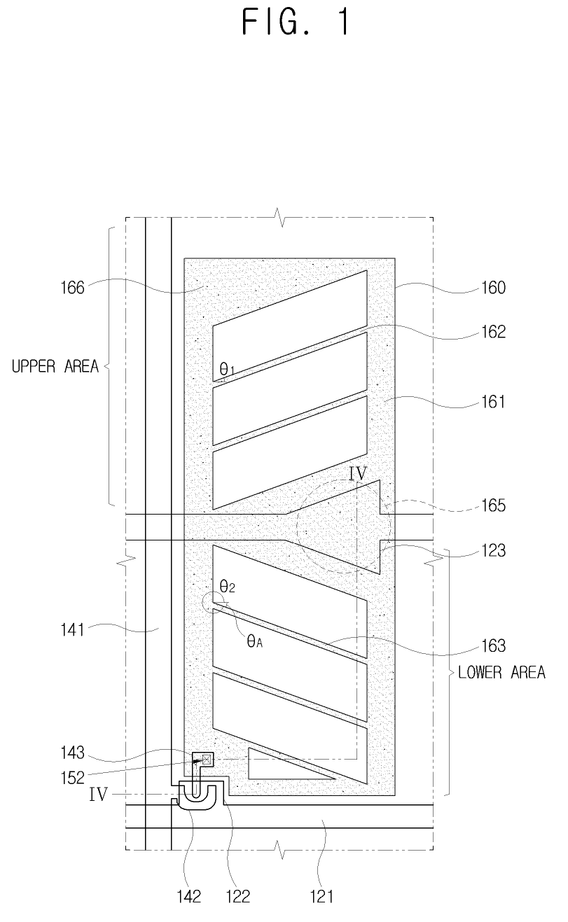

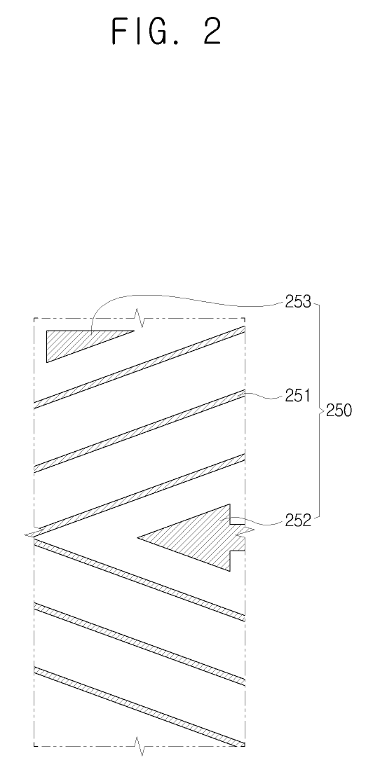

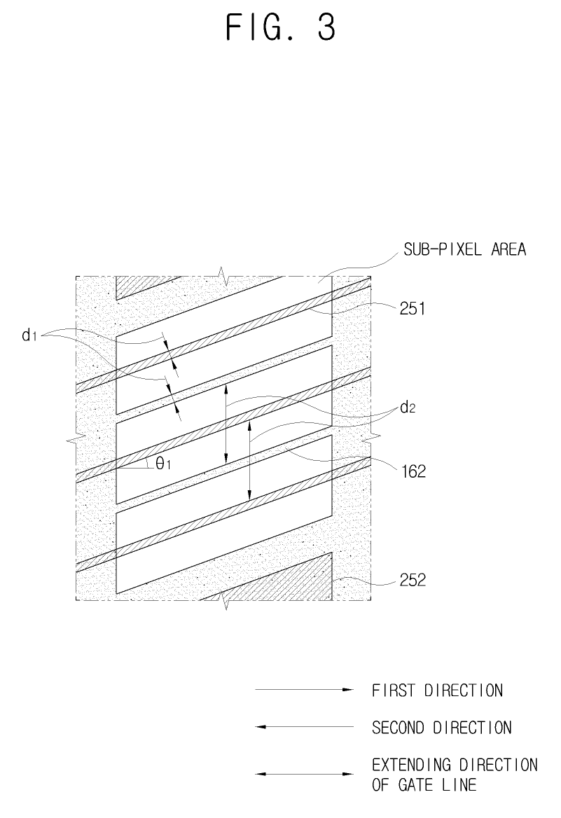

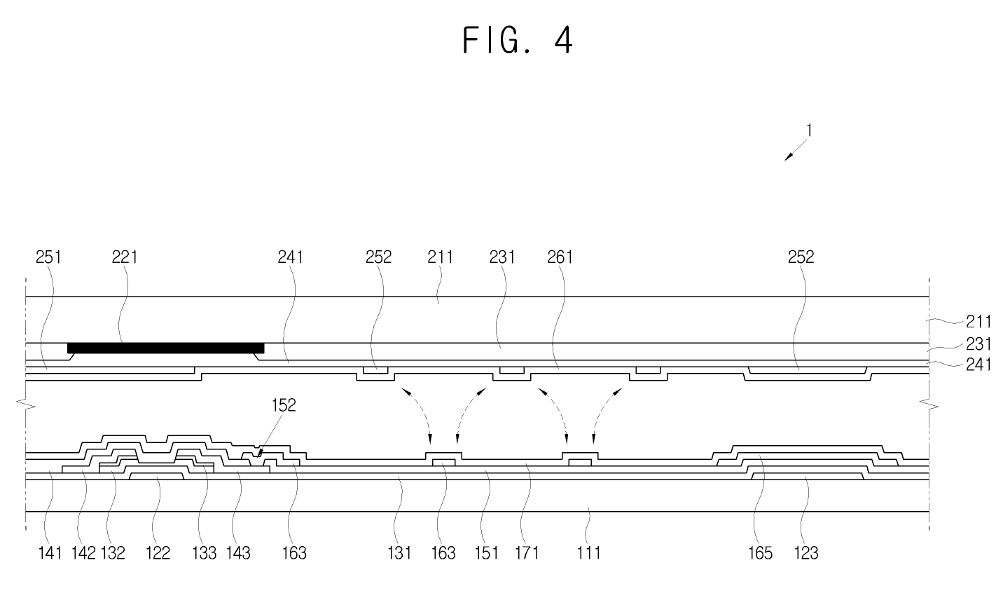

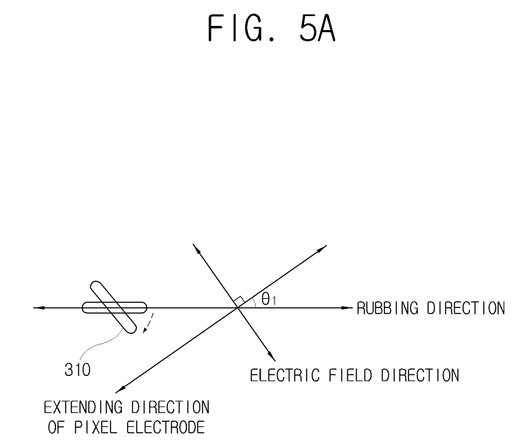

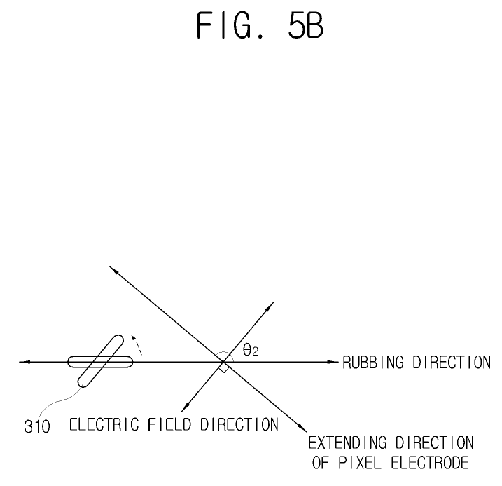

FIG. 1 is a plan view of a first substrate of an LCD device according to a first exemplary embodiment of the present invention. FIG. 2 is a plan view of a common electrode of the LCD device according to the first exemplary embodiment of the present invention. FIG. 3 is a plan view of the pixel electrode and the common electrode in the LCD device according to the first exemplary embodiment of the present invention. FIG. 4 is a sectional view taken along line IV-IV in FIG. 1. FIG. 5A and FIG. 5B are schematic diagrams to explain an orientation of a liquid crystal molecule in the LCD device according to the first exemplary embodiment of the present invention.

Hereinafter, an LCD device 1 according to a first exemplary embodiment of the present invention is described with reference to FIG. 1, FIG. 2, FIG. 3, FIG. 4, and FIG. 5.

Firstly, referring to FIG. 4, the LCD device 1 includes a first substrate 100 and a second substrate 200, which are arranged opposite and corresponding to each other, and a liquid crystal layer 300 disposed between the first substrate 100 and the second substrate 200. In this first embodiment, a liquid crystal molecule 310 of the liquid crystal layer 300 has a positive anisotropic dielectric constant, and is aligned so that its major axis is parallel with the first substrate 100 and the second substrate 200 if no electric field is applied to the liquid crystal layer 300, as shown in FIG. 5A and FIG. 5B. More specifically, the major axis is aligned with a rubbing direction if no electric field is applied to the liquid crystal layer 300. The rubbing direction will be explained in more detail below. If an electric field is applied to the liquid crystal layer 300, the liquid crystal molecule 310 is aligned so that its major axis becomes parallel with the electric field. Also, the liquid crystal molecule 310 may be tilted by an angle of about 0.5 degree to about 3 degrees from a direction parallel with the first substrate 100 and the second substrate 200. The tilted angle of the liquid crystal molecule 310 with respect to the first substrate 100 and the second substrate 200 is called pretilt angle. The pretilt angle helps the liquid crystal molecule 310 to align with an electric field if an electric field is applied and improves a response time.

The first substrate 100 will now be described with reference to FIG. 1, FIG. 2, FIG. 3, and FIG. 4.

Gate wirings 121, 122 and 123 are arranged on the first insulating substrate 111. Each gate wiring 121, 122 and 123 may be a single metal layer or a metal layer having multiple stacked sub-layers. The gate wirings 121, 122 and 123 include a gate line 121 extending in a direction that shall be referred to herein as an extending direction, a gate electrode 122 connected to the gate line 121, and a storage line 123. The extending direction of the gate line may include a first direction and a second direction, as shown in FIG. 3. The storage line 123 extends substantially parallel with the gate line 121 and has a triangular shape at a center portion of the pixel area. The triangular shape of the storage line 123 overlaps with a pixel storage electrode 165 of the pixel electrode 160 to function as a storage capacitor.

On the first insulating substrate 111, the gate wirings 121, 122 and 123 are covered by a gate dielectric film 131, which may include silicon nitride (SiNx).

A semiconductor layer 132 including amorphous silicon and/or other semiconductor material is arranged on the gate dielectric film 131 in an arrangement corresponding to the gate electrode 122. A resistance contact layer 133, which may include silicide, n+ hydrogenation amorphous silicon heavily doped with n type impurities, is arranged on the semiconductor layer 132. The resistance contact layer 133 is divided into two separated parts as described below.

Data wirings 141, 142 and 143 are formed on the resistance contact layer 133 and the gate dielectric film 131. The data wirings 141, 142 and 143 may also be a single layer or multiple stacked sub-layers. The data wirings 141, 142 and 143 include a data line 141 extending to cross substantially perpendicular with the gate line 121, a source electrode 142 connected to the data line 141 and arranged on an upper surface of a first part of the resistance contact layer 133, and a drain electrode 143 separated from the source electrode 142 and arranged on an upper surface of a second part of the resistance contact layer 133.

A pixel area is an area defined by the gate line 121 and the data line 141, and has approximately a rectangular shape in plan view. The pixel area is divided by the storage electrode 123 into an upper pixel area UPPER AREA and a lower pixel area LOWER AREA, as shown in FIG. 1.

A protection film 151 is arranged on the data wirings 141, 142 and 143 and on an exposed portion of the semiconductor layer 132 that is not covered by the data wirings 141, 142 and 143. The protection film 151 may include silicon nitride, a-Si:C:O or a-Si:O:F deposited by a plasma-enhanced chemical vapor deposition (PECVD) method, or acrylic organic insulator. The protection film 151 includes a contact hole 152 to expose the drain electrode 143.

The pixel electrode 160 is arranged on the protection film 151. Generally, the pixel electrode 160 may include a transparent conductor such as indium tin oxide (ITO) or indium zinc oxide (IZO). The pixel electrode 160 is connected to the drain electrode 143 through the contact hole 152. A first aligning film 171 is arranged on the pixel electrode 160.

The pixel electrode 160 includes a pair of stem electrodes 161 arranged parallel with the data line 141, a first branch electrode 162 and a second branch electrode 163 interconnecting the pair of stem electrodes 161, the pixel storage electrode 165 overlapping with the triangular region of the storage line 123 to function as a storage capacitor, and a first supplementary sustain electrode 166 arranged at an edge portion of the pixel area.

The first branch electrode 162 is arranged at an oblique angle with the gate line 121. Specifically, the first branch electrode 162 is tilted at a first angle θ₁ from the extending direction of the gate line 121. The second branch electrode 163 is tilted at an angle θ_{A} from the extending direction of the gate line 121. The first branch electrode 162 tilted at the first angle θ₁ and the second branch electrode 163 tilted at the angle θ_{A} are approximately symmetrical about the storage electrode 123, which extends parallel with the gate line 121, as an axis of symmetry.

The pixel storage electrode 165 is wider than the first branch electrode 162 and the second branch electrode 163, and is arranged between the upper pixel area UPPER AREA and the lower pixel area LOWER AREA. As explained above, a conventional pixel electrode having a branch electrode structure may include openings between the branches. Because the area of the pixel electrode is smaller than the pixel area, the pixel electrode may have a decreased storage capacity. A decrease in the storage capacity may lead to an increase in kickback voltage. The kickback voltage changes according to gradation and polarity since a pixel voltage applied to a pixel electrode in each frame varies. An increase in kickback voltage may result in flickering and a difference in brightness. Generally, the storage capacity of a conventional pixel electrode having a branch structure may be about 20% of a pixel electrode not having a branch electrode structure. Moreover, the liquid crystal molecule 310 orientation may not be well controlled at a center portion of the pixel area. Accordingly, the center portion of the pixel area may not have an influence on a light transmittance rate.

In the first exemplary embodiment of the present invention, the pixel storage electrode 165 is arranged at a center portion of the pixel area, which may not have an influence on the light transmittance rate, to increase the storage capacity. An increase in the storage capacity may decrease the kickback voltage, thus lessening the difference in the brightness and preventing errors caused by flickering.

The first supplementary storage electrode 166 also increases the storage capacity along with the pixel storage electrode 165, and functions as a storage capacitor along with a second supplementary sustain electrode 253 of the common electrode 250.

The second substrate 200 will now be described with reference to FIG. 2 and FIG. 4.

A black matrix 221 is arranged on a second insulating substrate 211. Generally, the black matrix 221 may be arranged to correspond to the semiconductor layer 132, and may prevent direct irradiation of light from outside the LCD device 1 onto the semiconductor layer 132 located on the first substrate 100. The black matrix 221 may include a photosensitive organic material containing a black pigment. The black pigment may include carbon or titanium oxide.

A color filter 231 has its boundary formed by the black matrix 221. The color filter 231 includes three sub-layers (not shown) which represent red, green and blue colors, respectively. The black matrix 221 may separate the three sub-layers from each other. The color filter 231 gives colors to the light irradiated from a backlight unit (not shown) and passed through the liquid crystal layer 300. The color filter 231 may include photosensitive organic material.

An over coat layer 241 is arranged on the color filter 231 and on the black matrix 221. The over coat layer 241 may include organic material to provide a flat surface. The over coat layer 241 may be omitted without detracting from the purpose of the present invention.

The common electrode 250 is arranged on the over coat layer 241, or may be arranged on the color filter 231 and on the black matrix 221 if the over coat layer 241 is omitted. The common electrode 250 includes transparent conductive material such as indium tin oxide (ITO) or indium zinc oxide (IZO). A potential difference between the common electrode 250 and the pixel electrode 160 generates an electric field that is applied to the liquid crystal layer 300.

A portion of the common electrode 250 is patterned in the pixel area. The patterned common electrode 250 includes a third branch electrode 251 intersecting the pixel area, a common storage electrode 252 arranged at the center portion of the pixel area, and the second supplementary storage electrode 253 arranged at an edge portion of the pixel area. However, the common electrode 250 according to this first exemplary embodiment does not include a stem electrode corresponding to the stem electrode 161 of the pixel electrode 160, so that the electric field near the stem electrode 161 is not distorted by a stem electrode of the common electrode 250, and texture along the edge portions of the pixel area may be prevented.

A third branch electrode 251 is arranged parallel with and between every first branch electrode 162 and second branch electrode 163 viewed in plan. Therefore, the third branch electrode 251 is also tilted by about the first angle θ₁ from the extending direction of the gate line 121, and is approximately symmetrical with a portion (not shown) of the common electrode 250 in the lower pixel area LOWER AREA about the common storage electrode 252 as an axis of symmetry. Specifically, a portion of the common electrode 250 in the lower pixel area LOWER AREA may be tiled by about the angle θ_{A} from the extending direction of the gate line 121, as shown for the second branch electrode 163 in FIG. 1.

The common storage electrode 252 overlaps with the pixel storage electrode 165 to function as a storage capacitor, and has a smaller area than the pixel storage electrode 165 to prevent the texture caused by the electric field. Also, the area of the second supplementary storage electrode 253 arranged at an edge portion of the pixel area is smaller than that of the first supplementary storage electrode 166.

A second aligning film 261 is formed on the common electrode 250.

The first aligning film 171 and the second aligning film 261 are rubbed in a direction parallel with the gate line 121 and the extending direction of the gate line 121.

An arrangement of the pixel electrode 160 and the common electrode 250 will now be described with reference to FIG. 3, which shows a part of the upper pixel area UPPER AREA.

Referring to FIG. 3, the pixel area is divided into sub-pixel areas. Each sub-pixel area is surrounded by the pixel electrode 160 and the common electrode 250. The sub-pixel areas each may have substantially the same size.

The sub-pixel area has a shape of a long extended parallelogram. Three sides of the sub-pixel area are bordered by the pixel electrode 160, and the fourth side of the sub-pixel area is bordered by the common electrode 250. Specifically, the sub-pixel area is bordered by a first stem electrode 161, a second stem electrode 161, the first branch electrode 162, and the third branch electrode 251. The first branch electrode 162 and the third branch electrode 251 bordering the sub-pixel area may have a width d₁ equal to or less than 6 μm. More specifically, the width d₁ may be equal to or less than 4 μm. The width of the branch electrodes may be as small as possible to improve the light transmittance ratio. A distance d₂ between two adjacent first branch electrodes 162 or between two adjacent third branch electrodes 251 may be between 25 μm and 45 μm.

The first branch electrode 162 of the pixel electrode 160 and the third branch electrode 251 of the common electrode 250 are arranged to be parallel with and opposite to each other in the sub-pixel area.

The sub-pixel area in the upper pixel area UPPER AREA and the sub-pixel area in the lower pixel area LOWER AREA extend in different directions to each other.

The first angle θ₁ between the first branch electrode 162 and the first direction of the gate line 121 may be between 0 degrees and 45 degrees, and more specifically, between 0 degrees and 30 degrees. The extending direction of the third branch electrode 251 and the first direction of the gate line 121 cross with each other at the first angle θ₁.

The first aligning film 171 is rubbed in the first direction parallel with the gate line 121. The second aligning film 261 is rubbed in the second direction parallel with but opposite to the first direction, which is the rubbing direction of the first aligning film 171.

A second angle θ₂ between the second branch electrode 163 and the first direction of the gate line 121 in the lower pixel area LOWER AREA may be between 135 degrees and 180 degrees, and more specifically between 150 degrees and 180 degrees. The second angle θ₂ is not shown in FIG. 3, but may be seen in FIG. 5B. The second angle θ₂ may be supplementary to the angle θ_{A}. The first angle θ₁ and the second angle θ₂ may also be supplementary. That is, the sum of the first angle θ₁ of the upper pixel area UPPER AREA and the second angle θ₂ of the lower pixel area LOWER AREA may be 180 degrees.

If the voltage is not applied, the liquid crystal molecule 310 of the liquid crystal layer 300 is aligned to be tilted at a pretilt angle, which is nearly parallel with the first insulating substrate 111 and the second insulating substrate 211. The major axis of the liquid crystal molecule 310 is aligned to be substantially parallel with the rubbing direction of the first aligning film 171 and the second aligning film 261.

If the electric field is generated by the application of a potential difference between the pixel electrode 160 and the common electrode 250, the alignment of the liquid crystal molecule 310 is described with reference to FIG. 4, FIG. 5A and FIG. 5B. The alignment of the liquid crystal molecule 310 in a horizontal direction is described in FIG. 5A and FIG. 5B. FIG. 5A represents the upper pixel area UPPER AREA, and FIG. 5B represents the lower pixel area LOWER AREA.

If a potential difference is applied between the pixel electrode 160 and the common electrode 250, the electric field is generated between the pixel electrode 160 and the common electrode 250 as shown as dotted arrows in FIG. 4. Specifically, the electric field is generated between the first branch electrode 162 and the third branch electrode 251, and between the second branch electrode 163 and the third branch electrode 251. Since the pixel electrode 160 and the common electrode 250 are vertically separated by the liquid crystal layer 300, the electric field has both a horizontal electric field component and a vertical electric field component. However, as the horizontal electric field component is dominant, the liquid crystal molecule 310 mostly adjusts the light transmittance rate by being rotated in a plane substantially parallel with the first insulating substrate 111 and the second insulating substrate 211.

As shown in FIG. 5A and FIG. 5B, the horizontal electric field component is formed to be substantially perpendicular to the extending direction of the pixel electrode 160, and the major axis of the liquid crystal molecule 310 is aligned substantially parallel to the electric field. As shown in FIG. 5A and FIG. 5B, the first angle θ₁ of the upper pixel area UPPER AREA is different than the second angle θ₂ of the lower pixel area LOWER AREA. Accordingly, a rotation direction of the liquid crystal molecule 310 in the upper pixel area UPPER AREA is different from that of the liquid crystal molecule 310 in the lower pixel area LOWER AREA, thus forming two domains. Thus, according to the present exemplary embodiment, one pixel area is divided into two domains to improve the range of visibility for the LCD device.

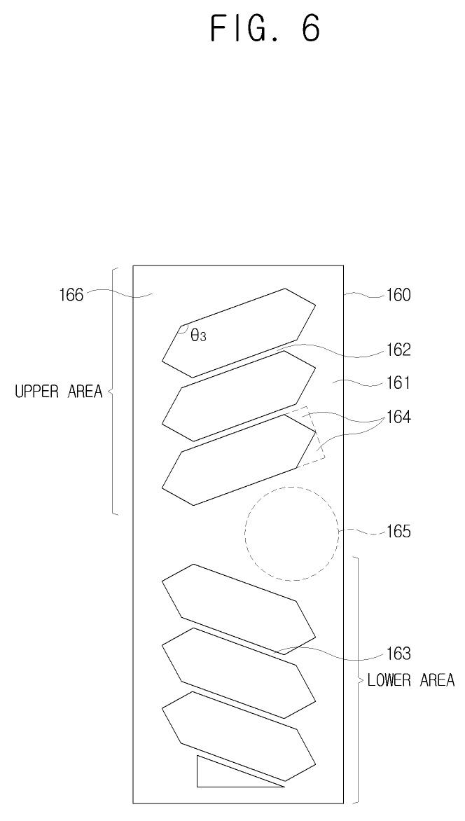

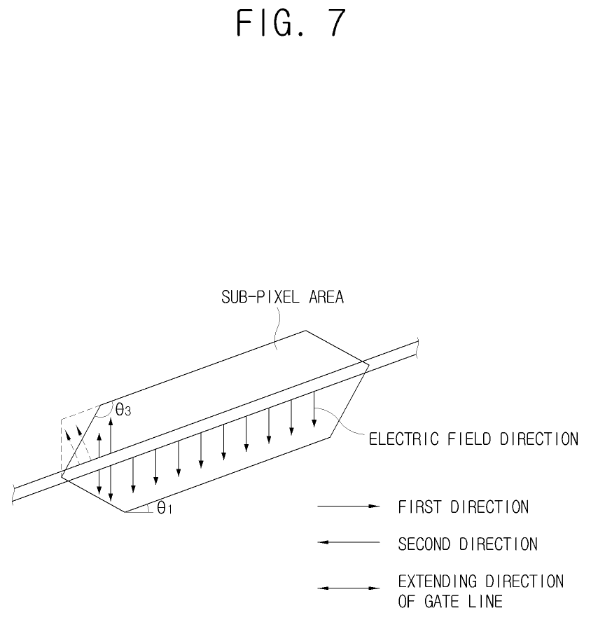

FIG. 6 is a plan view of a pixel electrode of an LCD device according to a second exemplary embodiment of the present invention. FIG. 7 is a plan view of a portion of the pixel electrode and a common electrode in the LCD device according to the second exemplary embodiment of the present invention. According to the second exemplary embodiment, the pixel electrode 160 further includes an edge electrode 164 arranged at a connecting area between a stem electrode 161 and first branch electrodes 162 and second branch electrodes 163. The edge electrode 164 extends between the first branch electrodes 162 and the second branch electrodes 163.

An edge electrode 164 of the pixel electrode 160 is located where the stem electrode 161 meets with each first branch electrode 162 and each second branch electrode 163. A third angle θ₃ between the edge electrode 164 and a first branch electrode 162 or a second branch electrode 163 may be between 90 degrees and 135 degrees. As shown in FIG. 7, the sub-pixel area of the pixel electrode 160 may have a trapezoidal shape.

The sub-pixel area and the pixel electrode 160 and the common electrode 250 which are surrounding the sub-pixel area are schematically described in FIG. 7. Referring to FIG. 7, the first angle θ₁ between the first branch electrode 162 and the first direction of the gate line 121 may be between 0 degrees and 45 degrees. The third branch electrode 251 and the first direction of the gate line 121 also cross with each other at the first angle θ₁. The electric field is formed from the third branch electrode 251 of the common electrode 250 to the first branch electrode 162 of the pixel electrode 160.

The dotted line shown in FIG. 7 represents a sub-pixel area where the edge electrode 164 is not formed. As shown in FIG. 7, if the edge electrode 164 is not formed, the edge portion of the sub-pixel area has an electric field aligned in a different direction. Thus, in this edge portion of the sub-pixel area, the alignment of the liquid crystal molecules 310 is not uniform, thus causing the texture along the edges of the sub-pixel area. The area where the texture arises does not contribute to the light transmittance rate. Therefore, the pixel electrode 160 according to the present exemplary embodiment has the edge electrode 164 at the edge part of the sub-pixel area so that the texture can be minimized and the liquid crystal molecules 310 can be aligned more uniformly. The aperture ratio may be improved by the minimized texture.

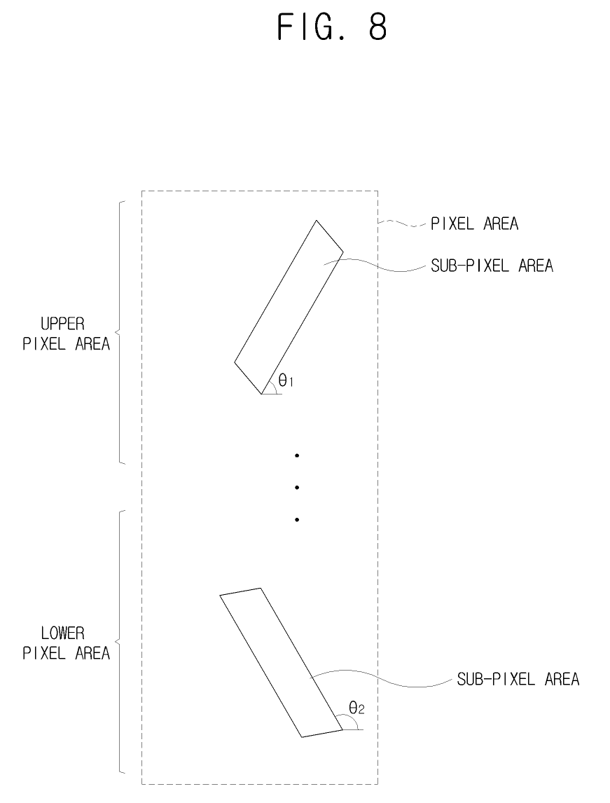

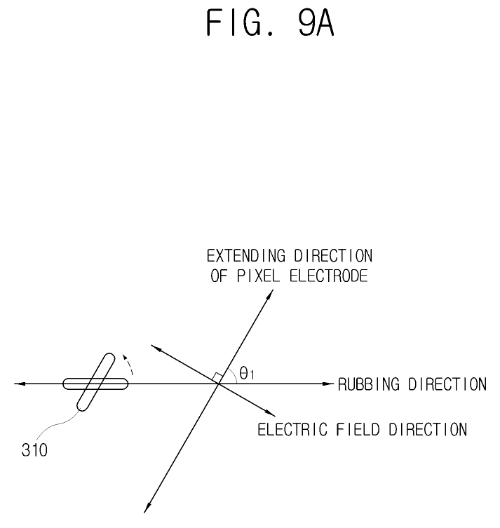

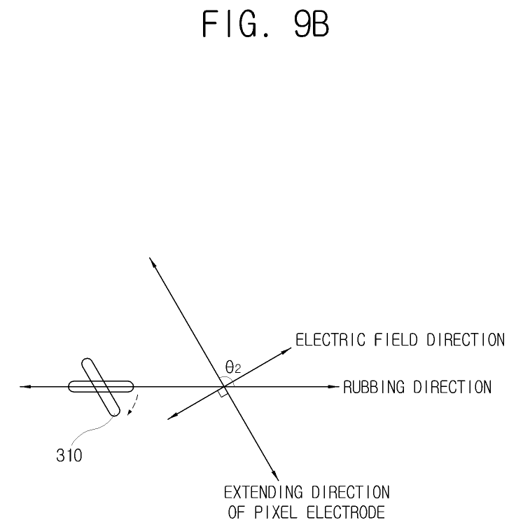

In the above exemplary embodiments, the liquid crystal molecule 310 of the liquid crystal layer 300 has a positive anisotropic dielectric constant. However, the liquid crystal molecule 310 of the liquid crystal layer 300 may have a negative anisotropic dielectric constant, which is explained hereinafter with reference to FIG. 8, FIG. 9A and FIG. 9B.

FIG. 8 is a plan view of an LCD device according to a third exemplary embodiment of the present invention. FIG. 9A and FIG. 9B are schematic diagrams to explain an alignment of a liquid crystal molecule in the LCD device according to the third exemplary embodiment of the present invention. FIG. 9A represents the upper pixel area, and FIG. 9B represents the lower pixel area.

Where the liquid crystal molecule 310 has a negative anisotropic dielectric constant, the distances between two adjacent first branch electrodes 162, two adjacent second branch electrodes 163, and two adjacent third branch electrodes 251 may be smaller than the distance d2 where the liquid crystal molecule 310 has the positive anisotropic dielectric constant. Specifically, the distances according to a third exemplary embodiment of the present invention may be between 8 μm and 14 μm. Since a negative anisotropic dielectric constant of a liquid crystal molecule 310 may have a smaller magnitude than a positive anisotropic dielectric constant, the distance between branch electrodes may be reduced to better control the alignment of the liquid crystal molecule 310. The distance between branch electrodes, which is described above, is variable according to the dielectric constant and other characteristics of the liquid crystal molecule 310, and may be adjusted by according to the condition of the LCD device by a user demand. For example, if an enhanced response time is demanded, the distance between electrodes may be decreased. On the contrary, if an improved light transmittance rate is preferred, the distance between electrodes may be increased. Therefore, the distance between electrodes will be set to the extent that the above conditions are properly satisfied.

Referring to FIG. 8, the pixel area comprises sub-pixel areas arranged in the upper pixel area and the lower pixel area so as to be symmetrical with each other. In the upper pixel area, the first angle θ₁ between the first branch electrode 162 of the pixel electrode 160 and the gate line 121 may be between 45 degrees and 90 degrees. In the lower pixel area, the second angle θ₂ may be between 90 degrees and 135 degrees. The sum of the first angle θ₁ of the upper pixel area and the second angle θ₂ of the lower pixel area may be 180 degrees.

Referring to FIG. 9A and FIG. 9B, if the electric field is generated, the horizontal electric field component is formed to be substantially perpendicular to the extending direction of the sub-pixel area, and the minor axis of the liquid crystal molecule 310 is aligned to be parallel with the electric field.

As noted above, FIG. 9A represents the upper pixel area, and FIG. 9B represents the lower pixel area. The first angle θ₁ of the upper pixel area is different than the second angle θ₂ of the lower pixel area. Accordingly, a rotation direction of the molecule 310 in the upper pixel area is different from that of the molecule 310 in the lower pixel area, thus forming two domains. As in previous exemplary embodiments of the present invention, one pixel area is divided into two domains to improve the range of visibility for the LCD device.

As described above, according to the present invention, a LCD device having an increased storage capacity to decrease a kickback voltage can be provided.

Also, according to the present invention, a LCD device having a decreased texture to improve image quality can be provided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a first insulating substrate;
a gate line and a data line arranged on the first insulating substrate and extending to cross with each other to define a pixel area;
a second insulating substrate opposing the first insulating substrate;
a pixel electrode arranged in the pixel area and connected to the data line, the pixel electrode comprising:
a stem electrode arranged parallel with the data line;
a plurality of first branch electrodes connected to the stem electrode and inclined at a first angle with respect to an extending direction of the gate line;
a plurality of second branch electrodes connected to the stem electrode and inclined at a second angle with respect to an extending direction of the gate line; and
a pixel storage electrode arranged between the first branch electrodes and the second branch electrodes and having a width greater than a width of a first branch electrode and a width of a second branch electrode; and
a common electrode arranged on the second insulating substrate and comprising:
an upper pixel area third branch electrode arranged between and substantially parallel with the first branch electrodes;
a lower pixel area third branch electrode arranged between and substantially parallel with the second branch electrodes; and
a common storage electrode corresponding to the pixel storage electrode.

2. The liquid crystal display device of claim 1, wherein the pixel electrode further comprises:
first edge electrodes arranged at connecting areas between the stem electrode and the first branch electrodes; and
second edge electrodes arranged at connecting areas between the stem electrode and the second branch electrodes,
wherein the first edge electrodes and the second edge electrodes extend between the first branch electrodes and between the second branch electrodes, respectively.

3. The liquid crystal display device of claim 2, wherein an angle between the first edge electrodes and the first branch electrodes is between 90 degrees and 135 degrees.

4. The liquid crystal display device of claim 1, wherein an area of the pixel storage electrode is larger than an area of the common storage electrode.

5. The liquid crystal display device of claim 1, wherein the pixel electrode further comprises:
a first supplementary storage electrode arranged at an edge portion of the pixel area.

6. The liquid crystal display device of claim 5, wherein the common electrode further comprises:
a second supplementary storage electrode corresponding to the first supplementary storage electrode.

7. The liquid crystal display device of claim 6, wherein an area of the first supplementary storage electrode is larger than an area of the second supplementary storage electrode.

8. The liquid crystal display device of claim 1, further comprising:
a third storage electrode arranged on a same layer as the gate line and overlapping with the pixel storage electrode.

9. The liquid crystal display device of claim 1, wherein the first branch electrodes and the second branch electrodes are substantially symmetrical with each other about an extending direction of the gate line.

10. The liquid crystal display device of claim 9, further comprising:
a first horizontal aligning film arranged on the pixel electrode and rubbed in a first direction; and
a second horizontal aligning film arranged on the common electrode and rubbed in a second direction,
wherein the first direction and the second direction are opposite in direction to each other and substantially parallel with the extending direction of the gate line.

11. The liquid crystal display device of claim 10, wherein an angle between an extending direction of the first branch electrodes and the extending direction of the gate line is between 0 degrees and 30 degrees, and an angle between an extending direction of the second branch electrodes and the extending direction of the gate line is between 0 degrees and 30 degrees.

12. The liquid crystal display device of claim 11, further comprising:
a liquid crystal layer arranged between the first insulating substrate and the second insulating substrate and comprising liquid crystals having a positive anisotropic dielectric constant,
wherein a distance between the first branch electrodes is between 25 μm and 45 μm, and a distance between the third branch electrodes is between 25 μm and 45 μm.

13. The liquid crystal display device of claim 11, further comprising:
a liquid crystal layer arranged between the first insulating substrate and the second insulating substrate and comprising liquid crystals having a negative anisotropic dielectric constant,
wherein a distance between the first branch electrodes is between 8 μm and 14 μm, and a distance between the third branch electrodes is between 8 μm and 14 μm.

14. The liquid crystal display device of claim 12, wherein a width of a first branch electrode is equal to or less than 6 μm, a width of a second branch electrode is equal to or less than 6 μm, and a width of a third branch electrode is equal to or less than 6 μm.

15. The liquid crystal display device of claim 13, wherein a width of a first branch electrode is equal to or less than 6 μm, a width of a second branch electrode is equal to or less than 6 μm, and a width of a third branch electrode is equal to or less than 6 μm.

16. A liquid crystal display device, comprising:
a first insulating substrate;
a gate line and a data line arranged on the first insulating substrate and crossing with each other to define a pixel area;
a pixel electrode comprising a stem electrode arranged parallel with the data line, a plurality of pixel branch electrodes connected to the stem electrode and inclined at a predetermined angle with respect to an extending direction of the gate line, an edge electrode arranged at connecting areas between the stem electrode and the pixel branch electrodes and extending between the pixel branch electrodes, and a pixel storage electrode having a width greater than a width of a pixel branch electrode;
a second insulating substrate opposing the first insulating substrate; and
a common electrode arranged on the second insulating substrate and comprising common branch electrodes arranged between and substantially parallel with the pixel branch electrodes, and a common storage electrode corresponding to the pixel storage electrode.

17. The liquid crystal display device of claim 16, wherein the pixel storage electrode is arranged at a center portion of the pixel electrode, and the pixel branch electrodes are substantially symmetrical with each other about an extending direction of the pixel storage electrode.

18. The liquid crystal display device of claim 16, wherein an area of the pixel storage electrode is larger than an area of the common storage electrode.

19. The liquid crystal display device of claim 16, wherein the pixel electrode further comprises a supplementary pixel storage electrode arranged at an edge portion of the pixel area.

20. The liquid crystal display device of claim 19, wherein the common electrode further comprises a supplementary common storage electrode corresponding to the supplementary pixel storage electrode.
